(19) United States
(12) Patent Application Publication
(10) Pub. No.: US 2008/0115510 A1
(43) Pub. Date: May 22, 2008

(54) Cryostats including current leads for electronically powered equipment

(75) Inventors: David Michael Crowley, Marlow (GB); Graham Gilgrass, Wallingford (GB); Wolfgang Stautner, Oxford (GB)

Correspondence Address: CROWELL & MORING LLP;INTELLECTUAL PROPERTY GROUP, P.O. BOX 14300, WASHINGTON, DC, 20044-4300, US

(73) Assignee: Siemens Magnet Technology Ltd., Oxon (GB)

(21) Appl. No.: 11/707,163

(22) Filed: Feb. 16, 2007

(30) Foreign Application Priority Data
Feb. 17, 2006 (GB) 0603166.0

(51) Int. Cl. F25B 19/00; H02G 3/03

(52) U.S. Cl. 62/51.1; 174/15.1

(57) ABSTRACT

A cryostat cooled by a pulse tube refrigerator and containing electrically powered equipment, wherein an electrical conductor is provided to the electrically powered equipment, said electrical conductor being in thermal and mechanical contact with one or more of the tubes of the pulse tube refrigerator.

The present invention relates to cryogenically cooled equipment, and particularly to arrangements for leading current into, and away from, equipment housed within a cryostat.

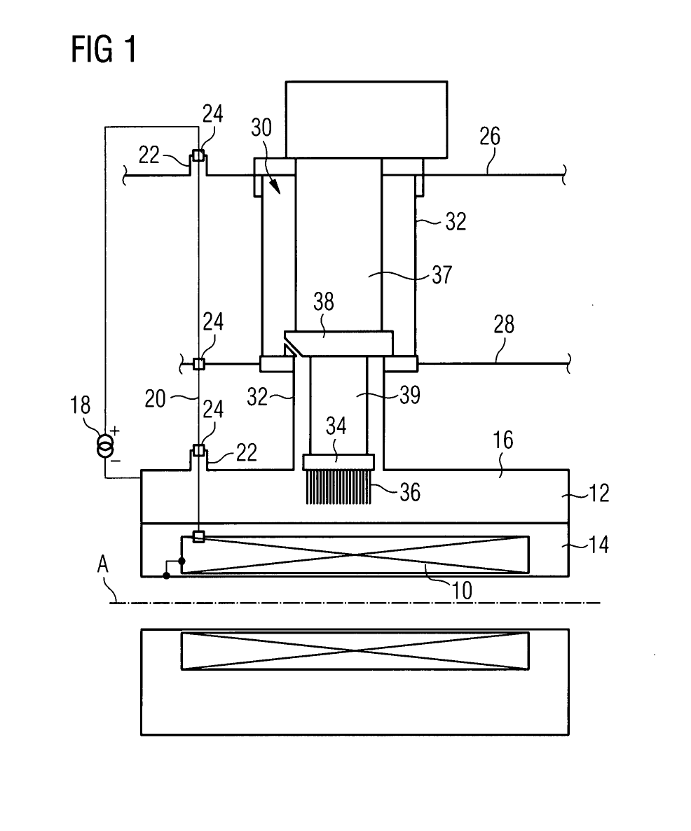

FIG. 1 illustrates a conventional cryostat housing a superconducting magnet 10. The magnet 10 is solenoidal, and substantially symmetrical about an axis A. The magnet is housed within a cryogen tank 12 which is at least partly filled with a liquid cryogen 14. The liquid cryogen boils at its boiling point, releasing boiled off cryogen vapour 16 into the remainder of the volume of the tank 12. Electrical current is introduced into the magnet 10 by way of a current source 18. As is conventional, a negative terminal of the current source is connected to the magnet through the body of the cryogen tank, which is typically of a metal such as stainless steel. A positive current lead 20 enters the cryogen tank through an access turret 22 and electrical isolators 24, to provide electrical current to the magnet. An outer vacuum container 26, only partially represented in FIG. 1, houses a thermally isolating vacuum, reducing thermal influx from the surrounding environment. A thermal shield 28, also only partially represented in FIG. 1, is typically provided to reduce heat transfer by thermal radiation between the outer vacuum container 26 and the cryogen tank 12. A recondensing refrigerator 30 is provided, to cool the cryogen within the cryogen tank 12. An access sock 32 is provided, being an opening between the outer vacuum container and the cryogen tank. The access sock may be open to the atmosphere of the cryogen tank, and so be filled with cryogen vapour. The refrigerator 30 may be of any known type, for example a pulse tube refrigerator (PTR). The refrigerator acts to cool its cold end 34 to below the boiling point of the cryogen 14. This will cause the cryogen vapour 16 to condense back into liquid form on the cold end, and drip back into the cryogen tank. A recondenser 36 may be provided, to increase the surface area of the cold end, and improve the efficiency of recondensation by the refrigerator 30. A warm end of the refrigerator may be thermally linked to the outer vacuum container 26. The illustrated refrigerator 30 is a two-stage refrigerator, having a first stage 37 cooling a first cold stage 38 thermally linked to the thermal shield 28, and a second stage 39 cooling its second cold stage, the cold end 34, in thermal contact with the cryogen vapour 16. In alternative arrangements, the sock 32 may be closed to the cryogen tank 12, and thermal conduction between the refrigerator and the cryogen vapour 16 may be through a solid sock wall.

In FIG. 1, the relative size of the sock 32 and the refrigerator 30 is exaggerated for clarity.

The positive current lead 20 provides an unwanted thermal path into the cryostat, allowing heat to leak into the cryostat from the exterior environment, in turn causing boil off of the cryogen 14 which must be counteracted by operation of the refrigerator 30. When current is being supplied to, or removed from, the magnet 10 during current ramping, heat will be generated within current lead 20 by ohmic (Joule) heating. If the heat influx through the current conductor could be prevented, a less powerful, and hence smaller and cheaper refrigerator 30 could be employed.

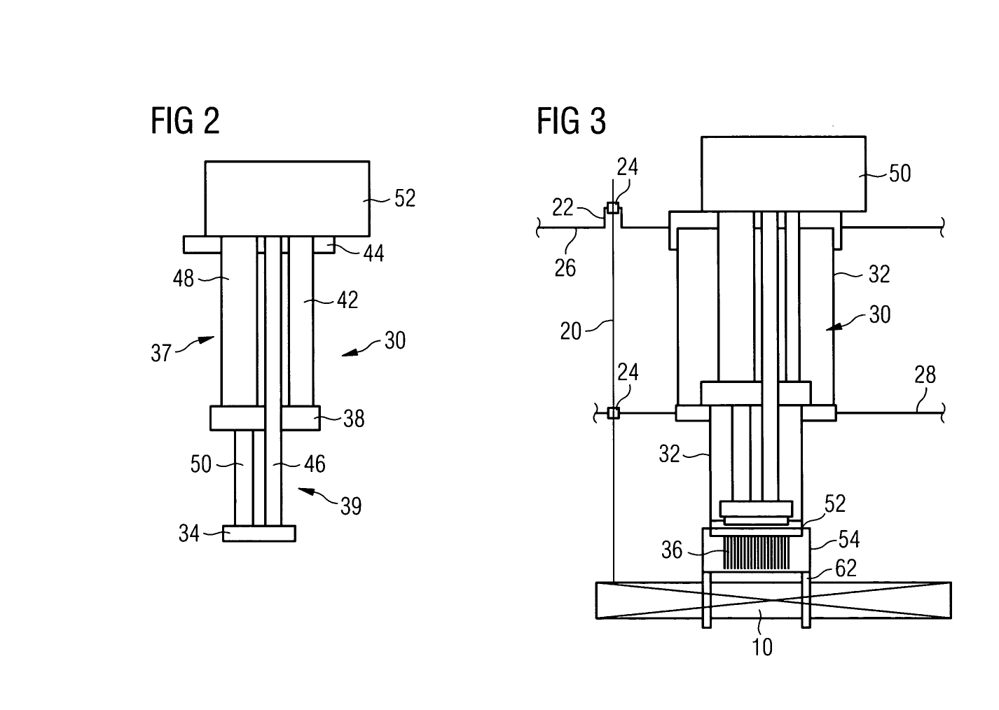

FIG. 2 shows a conventional pulse tube refrigerator in more detail. A first stage pulse tube 42 extends between the warm end 44 and the first cold stage 38. A second stage pulse tube 46 extends between the warm end 44 and the second cold stage 34. A first stage regenerator tube 48 extends between the warm end 44 and the first cold stage 38. A second stage regenerator tube 50 extends between the first cold stage 38 and the second cold stage 34. Valves housed within an upper part 52 of the refrigerator operate to connect high pressure gas, and gas return paths, to the pulse and regenerator tubes in a manner well known it itself, to provide cooling of the first and second cold stages 38, 34.

FIG. 3 illustrates a conventional pulse tube refrigerator, such as that illustrated in FIG. 2, installed within an access sock 32 of a dry cryostat housing a superconducting magnet 10. In this arrangement, a cryogen liquefaction cup 54 of a volume much smaller than the magnet 10 is provided. A number of thermally conductive paths 62 are provided, in thermal contact with the magnet 10. These conductive paths are connected to the cryogen liquefaction cup 54, which contains a small amount of cryogen. The refrigerator 30 is sealed from the cryogen liquefaction cup and acts through a cooling interface 52 to cool recondenser 36, to cool and maintain cryogen in cryogen liquefaction cup 54 in liquid form. This type of arrangement is advantageous over the arrangement of FIG. 1 at least in that a large volume of cryogen is not required, reducing costs. A large cryogen tank is not required, since the magnet and cryogen liquefaction cup 54 may be housed directly in the outer vacuum container 26. A positive current lead 20 is provided, in a manner analogous to that shown in FIG. 1.

The present invention aims to provide a current lead for admitting electrical current to cryogenically cooled equipment without providing an additional heat influx path. The present invention may be applied to ‘dry’ cryostats as illustrated in FIG. 3, as well as to ‘bath’ type cryostats as shown in FIG. 1.

The invention accordingly provides cryostats as defined in the appended claims.

The above, and further, objects, advantages and characteristics of the present invention will become more apparent from consideration of the following description of certain embodiments thereof, together with the accompanying drawings, wherein:

FIG. 1 shows a conventional cryostat housing a superconducting magnet;

FIG. 2 shows a conventional pulse tube refrigerator;

FIG. 3 shows a conventional pulse tube refrigerator, such as that illustrated in FIG. 2, installed within an access sock of a dry cryostat;

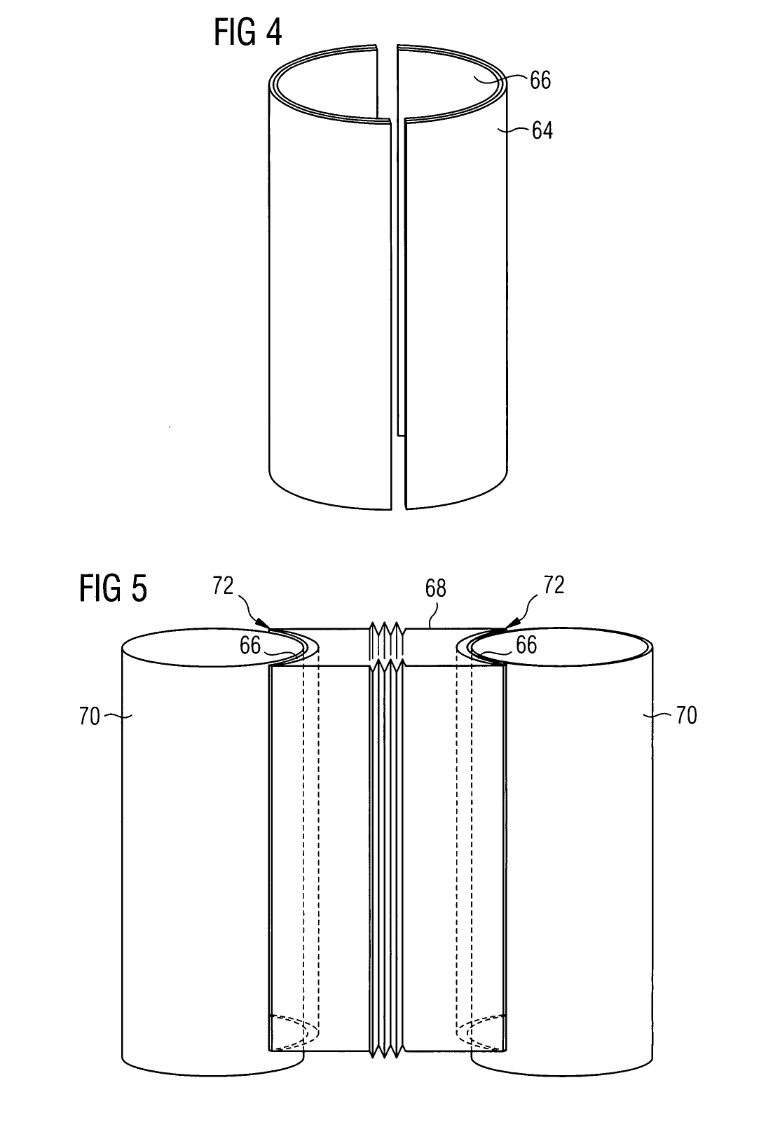

FIG. 4 shows an embodiment of current carrying conductor of the present invention;

FIG. 5 shows an alternative arrangement of an electrical conductor according to the present invention;

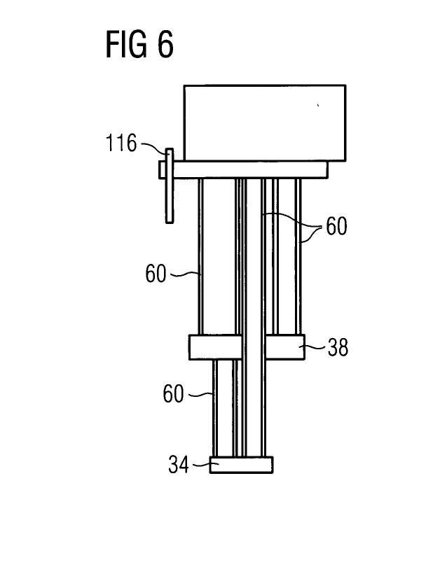

FIG. 6 shows individual vacuum tubes around each of the pulse and regenerator tubes of a pulse tube refrigerator, such that the vacuum tubes may be used as current carrying conductors;

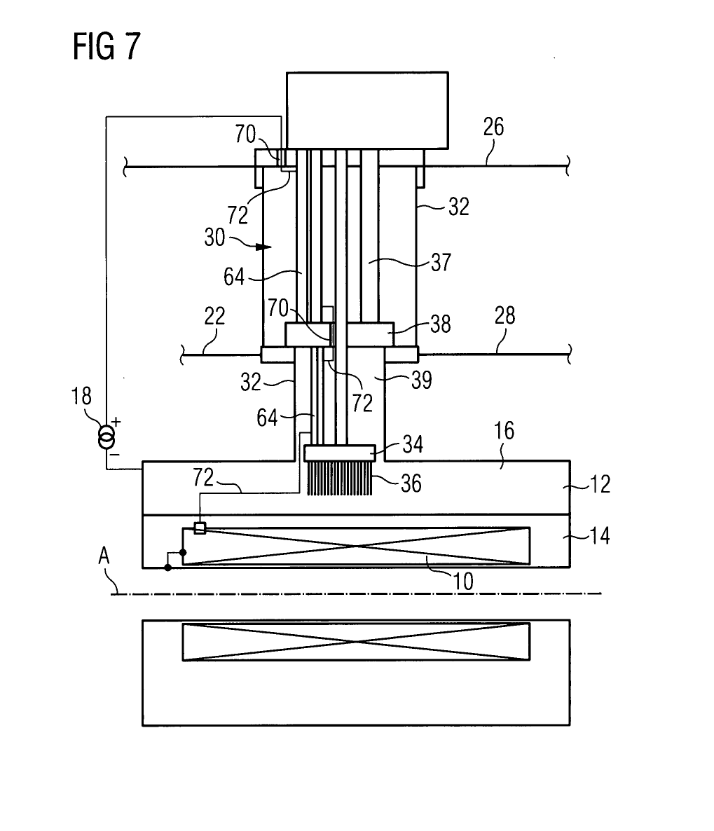

FIG. 7 shows a cryogenically cooled magnet as illustrated in FIG. 1, adapted according to the present invention; and

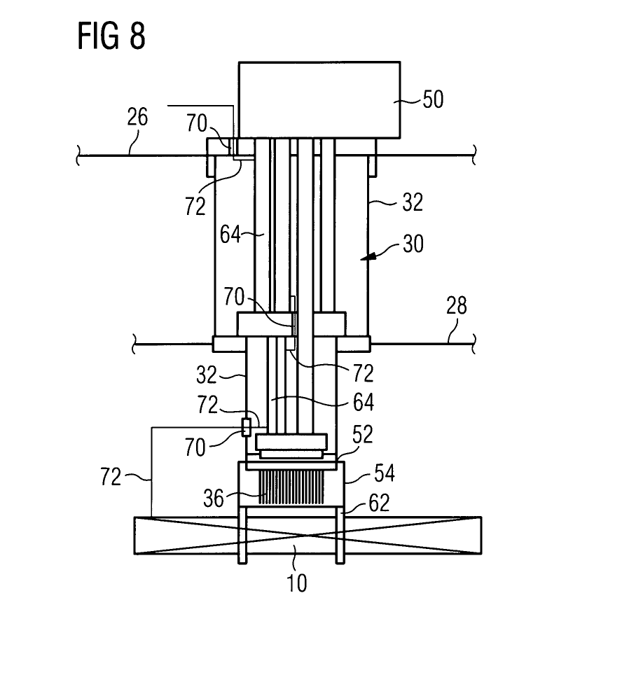

FIG. 8 shows a cryogenically cooled magnet as illustrated in FIG. 3, adapted according to the present invention.

The present invention provides an arrangement for housing a superconducting magnet within a vacuum vessel, with a cooling refrigerator, without the need for a separate current path to be led into the vacuum vessel. This is achieved according to the present invention by providing an electrical current path in thermal and mechanical connection with one or more of the tubes of a pulse tube refrigerator. The advantage of such an arrangement is that no additional heat path into the cryostat is provided, and the current lead is itself cooled by active refrigeration, being linked to the temperature gradient of the tube(s). The electrical conductor should be provided with an electrically insulating, thermally conductive layer interposed between the electrical conductor and the corresponding tube.

As is well known, the current leads are only required during ramping of the magnet, when electrical current is being introduced into the superconducting magnet. Once the magnet is operating at its desired operating current, no more current flows through the current lead of the present invention. It may be found advantageous to bring the current lead out of thermal and mechanical connection with the refrigerator once current injection is complete. There are provided a number of embodiments allowing this to be realised.

Known current lead cooling systems rely either on conduction cooling or gas cooling. The present invention provides a new arrangement for cooling the current lead, wherein a gas flow within a tube of a pulse tube refrigerator cools an attached current lead by conduction through thermally conducting walls of the tube. Since the gas is not exposed to the current lead, electrical breakdown of the gas within the pulse tube refrigerator is avoided.

The current lead arrangement of the present invention is particularly useful for operation at temperatures in the range of 50K to 300K. The arrangement is also particularly advantageous when applied to systems employing low- or high-temperature superconductors, particularly for magnetic resonance imaging systems. The present invention is also particularly applicable to dry systems—where the magnet is not immersed in a bath of liquid cryogen, but is cooled by other means. For example, the present invention may be applied to the ‘dry’ cryostat of FIG. 3, which requires much less liquid cryogen than the ‘bath’ type cryostat of FIG. 1.

An advantage of the present invention is that the heat load when operating the current lead and during steady state operation is reduced as compared to known current lead arrangements, since temperature distribution across the regenerator tube and the current lead of the present invention is shared, along the longitudinal axis of the regenerator tube.

The current lead of the present invention combines the respective advantages of a gas-cooled current lead and a conduction-cooled current lead.

Typically, the regenerator tube of a pulse tube refrigerator is composed of stainless steel with a typical wall thickness of 0.2 to 0.7 mm. If necessary, the tube thickness can be increased without significantly decreasing the performance of the cooler in the operating temperature range required, usually between 30K and 80K.

According to an embodiment of the present invention, a current carrying conductor is provided which is mechanically attached or clamped to the walls of a regenerator tube of a pulse tube refrigerator. Preferably, the current carrying conductor is in the form of two half-cylindrical metal sheets, which are electrically insulated from the material of the regenerator tube. In a certain embodiment of the invention, the current carrying conductor consists of two half cylinders of brass, lined with a self-adhesive polyimide film, such as that sold under the KAPTON™ brand by E. I. du Pont de Nemours and Company, for electrical insulation.

During magnet ramp, when current is being applied to the magnet coils, the current carrying conductor of the present invention indirectly transfers its thermal energy through the walls of the regenerator tube of the pulse tube refrigerator by thermal conduction, and thus exchanges heat with the cryogen gas, such as helium, cycling within the regenerator tube. Since heat flow is shared at every point of surface along the longitudinal axis of the regenerator tube, the temperature profile can change only slightly. As a result, only a small heat flow reaches the cold end 34 of the refrigerator 30.

For high power applications with operating currents in excess of about 1000 A, the pulse tube performance on the first stage of the dual stage cooler can be temporarily increased by known means, e.g. a power shift. The power shift technique involves a change to the timing of the valves admitting and releasing gas to/from the pulse tube refrigerator, to provide more cooling in the first stage of the refrigerator. In this case, the axial longitudinal temperature profile can be modified and the regenerator temperatures along the longitudinal axis reduced. On completion of magnet ramp, when the current in the magnet coils has reached its operational value, the pulse tube refrigerator resumes its operating frequency and timing for normal operating conditions, which is usually below 2 Hz.

The heat loads during ramping are calculated as approximately 25 W, 12 W, and <3 W at steady state 600 A current in the magnet 10. During ramping, which usually lasts for 30-45 seconds, a small increase in shield temperature, caused by an extra heat load to the radiation shield, can be tolerated. This extra heat load results from the ohmic heating of the current lead of the present invention.

In certain embodiments, a flow of cryogen gas, such as helium, is available to cool the outer surface of the current lead. This cooling effect may be <1 W, yet may effectively reduce the former 12 W load to 1.5 W. Such operation is facilitated by opening a valve on top of the sock. A vent path is typically provided to allow gas flow across the outer surface of the current lead. This is not used in normal operation. Heat transfer between the gas and the current lead may be improved by increasing the effective surface area of the current lead, with ribs or other known arrangements.

In further embodiments, parts of the pulse tube of the pulse tube refrigerator may be used as a current carrying arrangement, in parallel with the current lead on the regenerator tube.

U.S. Pat. No. 4,876,413 describes a known arrangement for using the whole body of a GM cooler as a current lead.

However, the temperature profile of a GM cooler does not lend itself to this heat reduction since the structural design of the GM cooler is different. Moreover, the temperature profile is very different and the length of the temperature profile is extremely small, not extending the full tube length. The present invention achieves the heat load reduction to the first stage by sharing the longitudinal axial temperature profile of the pulse tube refrigerator.

With a simple, externally-activated isolating spring mechanism or other disconnecting means, the sheets of the electrical conductor can be disconnected from contact with the tube(s) of the pulse tube refrigerator. In this case, no significant thermal heat load reaches the first stage of the cooler due to the presence of the electrical conductor.

FIG. 4 shows an embodiment of current carrying conductor of the present invention. It comprises a pair of conductive members 64, each lined with an electrically insulating, thermally conductive layer 66. Alternatively, or in addition, a thermally conductive, electrically insulating layer may be applied to the outer surface of the regenerator or pulse tube. In use, the two members 64 are pressed into mechanical and thermal contact with a regenerator tube, or pulse tube, of a pulse tube refrigerator. The conductive members are shaped to be conformal to an outer surface of the regenerator tube, or pulse tube. In the illustrated example, the conductive members are approximately half-cylindrical to conform to a cylindrical outer surface of the regenerator tube, or pulse tube. In a certain embodiment, the conductive members are two approximately half-cylindrical metal sheets. The conductive members may not be fully half-cylindrical, as the edges of the conductive members may not meet. Indeed, in some embodiments, it is preferred that they do not meet. The heat conducted along the members 64, and any heat generated within the members 64 by ohmic heating, is conducted to the regenerator tube, and is extracted by operation of the pulse tube refrigerator. Once current injection is complete, a mechanical arrangement may be provided to displace the members 64 away from the regenerator tube, so that they do not interfere with steady state operation of the pulse tube refrigerator.

FIG. 5 shows an alternative arrangement of an electrical conductor according to the present invention. A hollow electrically conductive member 68 is provided, extending along the length of a pair of regenerator or pulse tubes 70 of the pulse tube refrigerator. The conductive member 68 has surfaces 72 shaped to be conformal to the outer surfaces of the tubes 70 on two sides. The conductive member 68 shown in FIG. 5 has approximately half-cylindrical surfaces 72 to conform to cylindrical outer surfaces of the regenerator or pulse tubes 70. At least those surfaces are covered in a thermally conductive, electrically insulating layer 66, such as a self-adhesive polyimide film, or a composite material such as epoxy resin filled with glass fibre and/or aluminium oxide. Alternatively, or in addition, a thermally conductive, electrically insulating layer may be applied to the outer surfaces of the regenerator or pulse tubes 70. The material used for the member 68 preferably has a large coefficient of thermal expansion. When in use as a current injection conductor, ohmic heating will cause the member 68 to expand, pressing conformal surfaces 72 into thermal and mechanical contact with the tubes 70. Once ramping is complete, the current flow through, and hence the ohmic heating of, the member 68 will cease. It will cool to the temperature of the surrounding equipment, and in doing so will bring the conformal surfaces 72 out of thermal and mechanical contact with the tubes 70. In an alternate embodiment, the member 68 may be closed at each end, to form a gas-filled chamber. The expansion of the contained gas when heated by ohmic heating of the member 68 will assist in pressing the conformal surfaces 72 into contact with the tubes 70, while the contrary contraction of the gas when ohmic heating ceases assists in displacing the conformal surfaces 72 away from the tubes 70.

Considering again the arrangement of tubes in the conventional pulse tube refrigerator of FIGS. 2-3, the most effective position for locating the current carrying lead of the present invention is on the tube providing the greatest cooling—which is a pulse tube. The current conductor will be cooled by the associated tube to have a corresponding temperature gradient. Any heat conducted from ambient through the conductor, and any heat generated in the conductor itself, will be removed by conduction through the material of the tube to the gas inside the pulse tube refrigerator. The heat conducted in this way will then be removed from the system by operation of the pulse tube refrigerator.

Where electrical conduction must be provided across cold stages such as 38 in FIG. 2, a conventional terminal block with ceramic-insulated lead-through conductor 70 may be provided through the material of the cold stage. Similar conventional terminal blocks with ceramic-insulated lead-through conductors 70 may be provided to connect an electrical current through the top plate 44 of the refrigerator, and through the wall of the sock, where appropriate. A flexible conductor 72 such as copper ribbon or braid may be provided, bolted to the terminal block with ceramic-insulated lead-through conductor 70 and to the conductor of the present invention. In preferred embodiments, however, leads of high temperature superconductor may be used as conductors 72. Alternatively. It may be possible to provide a flexible conductor around the cold stages, electrically and mechanically connected to the conductor(s) of the present invention. Such flexible conductors may be braided or ribbon copper, or high temperature superconducting material. High temperature superconducting materials have the twin advantages of higher electrical conductivity and lower thermal conductivity as compared to copper.

Further embodiments of the invention may provide both supply and return current conductors according to the invention, rather than carrying the current in a return path through the body of the magnet and cryostat system. For example, using a conductor such as shown in FIG. 4, one conductive member may be arranged to be connected to the positive side of the current source, while the other half cylinder may be arranged to be connected to the negative side of the current source. Alternatively, two or more conductors according to the present invention may be provided, cooled by respective tubes of the pulse tube refrigerator, respectively connected to the positive and negative terminals of the current source. In a particular embodiment, the positive connection to the magnet 10 may be made through a conductor according to the present invention cooled by pulse tube 46. A parallel positive conductor according to the present invention may be provided, cooled by pulse tube 42. This may have the added advantage of spreading the heat load onto the pulse tube refrigerator, to reduce the disruption of its normal operation. The return path may be provided by a series connection of current paths, respectively cooled by regenerator tube 50, 48.

In known systems, the positive current lead has been cooled by a flow of escaping cryogen gas. The present invention provides cooling of the current lead by conduction to the refrigerator. This in turn leads to a reduced consumption of cryogen.

In certain embodiments of the invention, it may be found advantageous to form the conductors of the present invention of a material which expands when current flows through it, and contracts when the current ceases. This would provide improved thermal conductivity between the conductor and the refrigerator tube when required, during current flow on ramp up or ramp down, yet would reduce the thermal load on the refrigerator tube at other times when cooling of the conductor is not required.

In alternative embodiments of the present invention, vacuum tubes are provided, coaxially arranged with respect to individual pulse or regenerator tubes of the pulse tube refrigerator. As illustrated in FIG. 6, individual vacuum tubes 60 may be provided, around each of the pulse and regenerator tubes of the pulse tube refrigerator. These vacuum tubes may be used as current carrying conductors to take electrical current to and from the magnet 10 during ramping up and ramping down. When used in this way, the vacuum tubes 60 will be cooled by the pulse tube refrigerator either by thermal conduction along the length of the vacuum tube to the cold stages 38, 34, or by thermal radiation to the material of the corresponding pulse or regenerator tube.

FIG. 7 shows a cryogenically cooled magnet as illustrated in FIG. 1, adapted according to the present invention, such that the current conductor 20 is replaced by a current conductor 64 of the present invention, cooled by tubes of the pulse tube refrigerator 30. Similarly, FIG. 8 shows a cryogenically cooled magnet as illustrated in FIG. 3, adapted according to the present invention, such that the current conductor 20 is replaced by a current conductor 64 of the present invention, cooled by tubes of the pulse tube refrigerator 30.

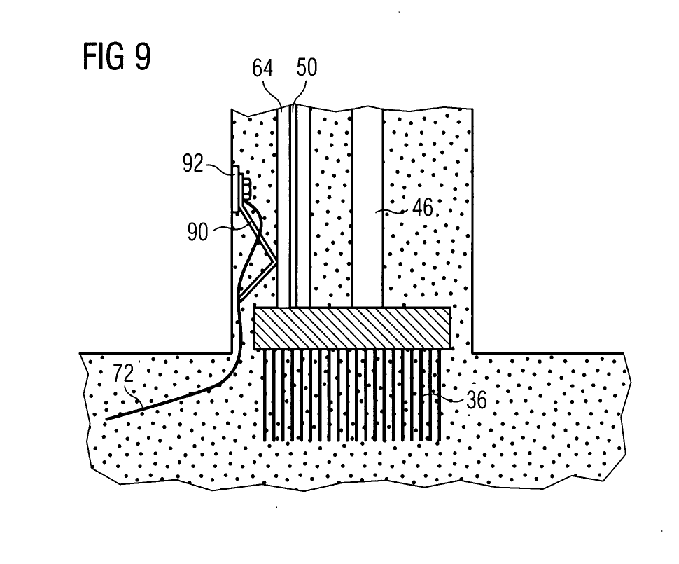

In certain embodiments of the present invention, an electrical contact may be provided within the sock, such that the conductor of the present invention makes electrical contact with the magnet when the refrigerator is inserted, yet the refrigerator is not prevented from being withdrawn for servicing when required. FIG. 9 shows one possible implementation of such a contact, suitable for provision within the sock. As shown in FIG. 9, a sprung electrical contact 90 is provided, mechanically mounted to the wall of the sock but electrically isolated therefrom by insulating material 92, in a conventional arrangement. Electrical conductor 72 is electrically connected to the contact 90. The electrical contact 90 is formed of such material and in such shape that it will be resiliently biased into electrical contact with the conductor of the present invention when the refrigerator is in operating position, but will be resiliently deformed by the refrigerator to allow the refrigerator to be removed and replaced for servicing operations.

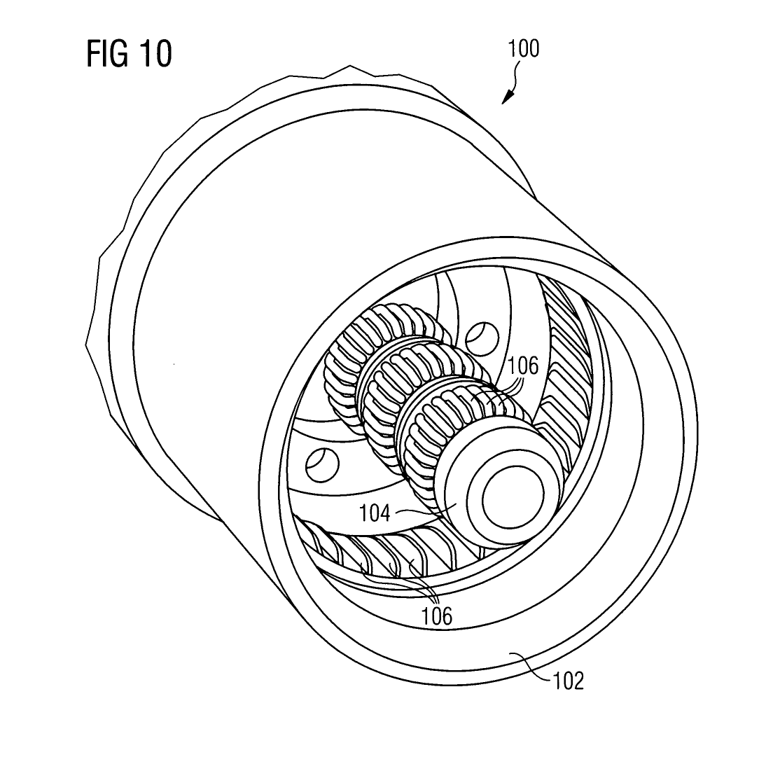

FIG. 10 illustrates an example of a coaxial electrical connector in an embodiment of the present invention. A pulse tube refrigerator 100 terminates at its lower end with a coaxial arrangement of connectors. An outer connector 102 is provided as one electrical connector, while a concentric inner connector 104 is provided as the other electrical connector. Typically, the outer connector 102 will connect to the body of the cryostat as a return path, while the inner connector 104 will connect to a positive current terminal of the magnet to provide current. As illustrated, each terminal 102, 104 is preferably formed with resilient contact members 106. In operation, the concentric connector of FIG. 10 is brought into mating contact with a corresponding socket. The contact members 106 are then deformed into reliable but removable electrical connection with the corresponding socket.

While the present invention has been described with reference to a limited number of particular embodiments, various modifications and variations may be made within the scope of the present invention.

1. A cryostat cooled by a pulse tube refrigerator, itself comprising at least one pulse tube and at least one regenerator tube, and containing electrically powered equipment, wherein an electrical conductor is provided to the electrically powered equipment, said electrical conductor being in thermal and mechanical contact with one or more of the tubes of the pulse tube refrigerator, said electrical conductor also being conformal to an outer surface of said one or more tube(s).

2. A cryostat according to claim 1, wherein the outer surface of said one or more tube(s) is cylindrical.

3. A cryostat according to claim 1, wherein the electrical conductor is arranged to be brought out of thermal and mechanical connection with the tubes(s) of the pulse tube refrigerator when electrical current conduction is not required.

4. A cryostat cooled by a pulse tube refrigerator, itself comprising at least one pulse tube and at least one regenerator tube, and containing electrically powered equipment, wherein an electrical conductor is provided to the electrically powered equipment, said electrical conductor being in thermal and mechanical contact with one or more of the tubes of the pulse tube refrigerator, wherein the electrical conductor is arranged to be brought out of thermal and mechanical connection with the tubes(s) of the pulse tube refrigerator when electrical current conduction is not required.

5. A cryostat according to claim 1, wherein an electrically insulating, thermally conductive layer is provided, interposed between the electrical conductor and the corresponding tube(s).

6. A cryostat according to claim 1, wherein the electrical conductor is in the form of two approximately half-cylindrical metal sheets, which are electrically insulated from the material of the tubes(s) of the pulse tube refrigerator.

7. A cryostat according to claim 6, wherein the electrical conductor consists of two approximately half-cylindrical sheets of brass, lined with a self-adhesive polyimide film, for electrical insulation.

8. A cryostat according to claim 6, wherein the electrical conductor consists of two approximately half-cylindrical sheets of brass, lined with epoxy resin filled with glass and/or aluminum oxide.

9. A cryostat according to claim 1, wherein a flow of cryogen gas is provided to cool the outer surface of the electrical conductor.

10. A cryostat according to claim 1, wherein the electrical conductor comprises a hollow electrically conductive member extending along the length of a pair of regenerator or pulse tubes of the pulse tube refrigerator; the conductive member being shaped to be conformal to the surfaces of the tubes on two sides wherein an electrically insulating, thermally conductive layer is provided, interposed between the hollow electrically conductive member and the corresponding tubes.

11. A cryostat according to claim 10, wherein the thermally conductive, electrically insulating layer comprises a self-adhesive polyimide film, or a composite material, or specifically epoxy resin filled with glass fiber and/or aluminum oxide.

12. A cryostat according to claim 10, wherein, in use as an electrical conductor, ohmic heating will cause the electrically conductive member to expand, pressing conformal surfaces into thermal and mechanical contact with the tubes; and, when not in use as an electrical conductor, the electrically conductive member cools and in doing so brings the conformal surfaces out of thermal and mechanical contact with the tubes 70.

13. A cryostat according to claim 10, wherein the electrically conductive member is closed at each end, forming a gas-filled chamber, such that when the electrically conductive member is in use as an electrical conductor, ohmic heating causes expansion of the contained gas assisting in pressing the conformal surfaces into contact with the tubes, while the contrary contraction of the gas when ohmic heating ceases assists in displacing the conformal surfaces away from the tubes.

14. A cryostat according to claim 6, wherein one approximately half-cylindrical sheet is arranged to be connected to the positive side of a current source, while the other approximately half-cylindrical sheet is arranged to be connected to the negative side of the current source.

15. A cryostat according to claim 1, wherein two electrical conductors are provided to the electrically powered equipment, each electrical conductor being in thermal and mechanical contact with a respective tube of the pulse tube refrigerator, each connected to a respective one of positive and negative terminals of a current source.

16. A cryostat cooled by a pulse tube refrigerator and containing electrically powered equipment, wherein an electrical conductor is provided to the electrically powered equipment, said electrical conductor coaxially arranged with respect to an individual pulse or regenerator tube of the pulse tube refrigerator, and isolated therefrom by a vacuum region.

17. A cryostat according to claim 1, wherein an electrical contact is provided such that the electrical contact is resiliently biased into electrical contact with the electrical conductor when the refrigerator is in its operating position, but is resiliently deformed by the refrigerator when the refrigerator is removed and replaced.
